(19) United States
(12) Patent Application Publication
(10) Pub. No.: US 2013/0170836 A1
(43) Pub. Date: Jul. 4, 2013

(54) OPTICAL TRANSCEIVER AND WAVELENGTH INITIALIZATION METHOD USING OPTICAL TRANSCEIVER

(71) Applicant: Electronics and Telecommunications Research, Daejeon (KR)

(72) Inventors: Jie Hyun LEE, Daejeon (KR); Seung Hyun CHO, Daejeon (KR); Seung Il MYOUNG, Daejeon (KR); Eun Gu LEE, Daejeon (KR); Han Hyub LEE, Daejeon (KR); Eui Suk JUNG, Daejeon (KR); Kwang Ok KIM, Jeonbuk (KR); Jong Hyun LEE, Daejeon (KR); Sang Soo LEE, Daejeon (KR)

(73) Assignee: Electronics and Telecommunications Research Institute, Daejeon (KR)

(21) Appl. No.: 13/624,547

(22) Filed: Sep. 21, 2012

(30) Foreign Application Priority Data
Dec. 30, 2011 (KR) 10-2011-0147677

(51) Int. Cl. H04J 14/02

(52) U.S. Cl. 398/87; 398/79; 398/96

(57) ABSTRACT

An optical transceiver, and a wavelength initialization method using the optical transceiver are provided. The optical transceiver may include an optical transmitter to transmit an upstream signal using a first waveguide Bragg grating (WBG), an optical receiver to receive a downstream signal using a second WBG, and a control unit to control the second WBG to initialize a wavelength, so that the optical receiver receives a maximum optical power.

### CROSS-REFERENCE TO RELATED APPLICATION

This application claims the benefit of Korean Patent Application No. 10-2011-0147677, filed on Dec. 30, 2011, in the Korean Intellectual Property Office, the disclosure of which is incorporated herein by reference.

### BACKGROUND

1. Field of the Invention

The present invention relates to a method of initializing an optical transceiver equipped with a wavelength variable optical source that is used in a wired optical network in which a wavelength division multiplexing (WDM) scheme and a time division multiplexing (TDM) scheme are used together, in a wireless network used to operate a separable base station, or in a network in which a wired network and a wireless network are used together, or relates to a method of selecting or initializing a wavelength of an optical transceiver equipped with a wavelength selectable optical source.

2. Description of the Related Art

A time division multiplexing (TDM) scheme refers to an optical communication method that may accommodate a plurality of subscribers by allocating a time slot to each of the subscribers. Additionally, a wavelength division multiplexing (WDM) scheme refers to an optical communication method that may allocate a unique wavelength to each of a plurality of subscribers, to provide the subscribers with a high-speed broadband communication service, and to facilitate communication security and expansion of a line.

Due to an increase in use of the internet, and an explosive increase in demand for multimedia content, an increase in a bandwidth of a network is required. To increase the bandwidth, the WDM scheme may be applied to all of a wired optical network, a wireless network, and a network in which the wired optical network and the wireless network are used together, and the WDM scheme and the TDM scheme may be used together.

However, when a plurality of wavelengths are multiplexed in a single optical fiber using the WDM scheme, the same number of optical sources with different wavelengths as a number of subscribers may be required. Accordingly, producing, installing and managing optical sources for each wavelength may become a great financial burden to both a user and an enterpriser. To solve such an issue, various researches have been conducted to apply a wavelength variable optical source or a wavelength selectable optical source.

Since an output wavelength of the wavelength variable optical source or an output wavelength of the wavelength selectable optical source is not determined, a wavelength initialization process of determining an output wavelength of an optical source to be a wavelength allocated to a subscriber is necessarily required to use the wavelength variable optical source or the wavelength selectable optical source in an optical link employing the WDM scheme.

### SUMMARY

An aspect of the present invention provides a method of initializing a wavelength of a wavelength variable optical source or a wavelength selectable optical source, in a wired optical network, in a wireless network used to operate a separable base station, or in a network in which a wired network and a wireless network are used together.

According to an aspect of the present invention, there is provided an optical transceiver, including: an optical receiver to receive a downstream signal using a first wavelength selective filter comprising a first waveguide Bragg grating (WBG); a control unit to control the first WBG to initialize a wavelength, so that the optical receiver receives a maximum optical power; and an optical transmitter to transmit an upstream signal using a second wavelength selective filter comprising a second WBG, wherein the second WBG is controlled by the control unit, together with the first WBG.

wherein the first WBG and the second WBG is separated from a gain medium or is unified with the gain medium.

wherein a central Bragg wavelength of the first WBG and a central Bragg wavelength of the second WBG are set to be spaced apart from each other by a free spectral range (FSR) of a wavelength division multiplexer/demultiplexer (WDM MUX/DeMUX).

wherein the upstream signal and the downstream signal are located in wavelength bands that are spaced apart from each other by an integer multiple of an FSR of a WDM MUX/DeMUX.

According to another aspect of the present invention, there is provided an optical transceiver, including: an optical receiver to receive a downstream signal using a first wavelength selective filter; a control unit to control the first wavelength selective filter to initialize a wavelength, so that the optical receiver receives a maximum optical power; and an optical transmitter to transmit an upstream signal using a second wavelength selective filter connected to a partial mirror, wherein the second wavelength selective filter is controlled by the control unit, together with the first wavelength selective filter.

wherein a free spectral range (FSR) of the wavelength selective filter is identical to an FSR of a wavelength division multiplexer/demultiplexer (WDM MUX/DeMUX).

wherein the optical receiver receives an downstream signal using a first wavelength selective filter, and wherein the optical transmitter transmits a upstream signal using a second wavelength selective filter that is different from the first wavelength selective filter.

wherein a transmission wavelength of the first wavelength selective filter, and a transmission wavelength of the second wavelength selective filter are spaced apart from each other by an interval that corresponds to an FSR of a WDM MUX/DeMUX.

According to another aspect of the present invention, there is provided an optical transceiver, including: an optical receiver to receive a downstream signal using a iₜₕ wavelength of first wavelength band; and an optical transmitter to transmit an upstream signal using a iₜₕ wavelength of second wavelength band, wherein the difference between the iₜₕ wavelength of the first wavelength band and the iₜₕ wavelength of the second wavelength band is fixed or changed.

According to another aspect of the present invention, there is provided an optical transceiver, including: an optical receiver to receive a downstream signal in a first wavelength of first wavelength band; a control unit to control a first wavelength selective filter so that the optical receiver receives a maximum optical power; and an optical transmitter to transmit an upstream signal using a second wavelength selective filter in a second wavelength of second wavelength band, wherein the second wavelength selective filter is controlled by the control unit, together with the first wavelength selective filter.

when at least one of the first wavelength selective filter and the second wavelength selective filter are multiple thin filter, wherein the control unit control a refractive of multiple thin filter by applying the electric, and when at least one of the first wavelength selective filter and the second wavelength selective filter are waveguide Bragg grating, wherein the control unit control a grating period of waveguide Bragg grating by applying the heat.

According to another aspect of the present invention, there is provided a wavelength initialization method, including: controlling, by the control unit, the first WBG to initialize a wavelength, so that the optical receiver receives a maximum optical power; and transmitting, by the optical transmitter, an upstream signal using a wavelength selective filter comprising a second WBG, wherein the second WBG is controlled by the control unit, together with the first WBG.

wherein the first WBG and the second WBG is separated from a gain medium or is unified with the gain medium.

wherein a central Bragg wavelength of the first WBG and a central Bragg wavelength of the second WBG are set to be spaced apart from each other by a free spectral range (FSR) of a wavelength division multiplexer/demultiplexer (WDM MUX/DeMUX).

wherein the upstream signal and the downstream signal are located in wavelength bands that are spaced apart from each other by an integer multiple of an FSR of a WDM MUX/DeMUX.

According to another aspect of the present invention, there is provided a wavelength initialization method, including: receiving, by the optical receiver, a downstream signal using the first wavelength selective filter; controlling, by the control unit, the first wavelength selective filter to initialize a wavelength, so that the optical receiver receives a maximum optical power; and transmitting, by the optical transmitter, an upstream signal using a second wavelength selective filter connected to a partial mirror, wherein the second wavelength selective filter is controlled by the control unit, together with the first wavelength selective filter.

wherein a free spectral range (FSR) of the wavelength selective filter is identical to an FSR of a wavelength division multiplexer/demultiplexer (WDM MUX/DeMUX).

wherein the receiving comprises receiving, by the optical receiver, a downstream signal using the first wavelength selective filter; wherein the controlling comprises controlling, by the control unit, the first wavelength selective filter to initialize the wavelength, so that the optical receiver receives the maximum optical power, and wherein the transmitting comprises transmitting, by the optical transmitter, an upstream signal using a second wavelength selective filter different from the first wavelength selective filter.

wherein a transmission wavelength of the first wavelength selective filter, and a transmission wavelength of second wavelength selective filter are spaced apart from each other by an interval that corresponds to an FSR of a WDM MUX/DeMUX.

wherein the optical transceiver is connected to an optical link comprising a WDM MUX/DeMUX.

wherein the optical transceiver is one of elements included in a network in which a wired network and a wireless network are combined.

According to another aspect of the present invention, there is provided a wavelength initialization method, including: receiving, by the optical receiver, a downstream signal using a iₜₕ wavelength of first wavelength band; and transmitting by the optical transmitter, an upstream signal using the iₜₕ wavelength of second wavelength band, wherein the difference between the iₜₕ wavelength of the first wavelength band and the iₜₕ wavelength of the second wavelength band is fixed or changed.

According to another aspect of the present invention, there is provided a wavelength initialization method, including: receiving a downstream signal in a first wavelength of first wavelength band; controlling a first wavelength selective filter so that the optical receiver receives a maximum optical power; and transmitting an upstream signal using a second wavelength selective filter in a second wavelength of second wavelength band, wherein the second wavelength selective filter is controlled by the control unit, together with the first wavelength selective filter.

when at least one of the first wavelength selective filter and the second wavelength selective filter are multiple thin filter, wherein the control unit control a refractive of multiple thin filter by applying the electric, and when at least one of the first wavelength selective filter and the second wavelength selective filter are waveguide Bragg grating, wherein the control unit control a grating period of waveguide Bragg grating by applying the heat.

### Effect

According to embodiments of the present invention, a wavelength of a wavelength variable optical source or a wavelength selectable optical source may be initialized in a wired optical network, in a wireless network used to operate a separable base station, or in a network in which a wired network and a wireless network are used together, and thus it is possible to efficiently and easily manage and operate a network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an optical link based on a wavelength division multiplexing (WDM) scheme, or an optical link based on a time division multiplexing (TDM) scheme, according to an embodiment of the present invention;

FIG. 2 is a diagram illustrating an optical link to which a WDM scheme is applied, according to an embodiment of the present invention;

FIG. 3 is a diagram illustrating a detailed configuration of a wavelength variable optical source or a wavelength selectable optical source, according to an embodiment of the present invention;

FIG. 4 is a diagram illustrating a configuration of an optical link for wavelength initialization according to an embodiment of the present invention;

FIG. 5 is a diagram to explain a wavelength initialization method using a waveguide Bragg grating (WBG) as a wavelength selective filter according to an embodiment of the present invention;

FIG. 6 is a diagram to explain a wavelength initialization method using a wavelength selective filter that is different from a wavelength selective filter of FIG. 5 according to an embodiment of the present invention; and

FIG. 7 is a diagram to explain a wavelength initialization method in which an optical transmitter and an optical receiver use different wavelength selective filters, according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

In the drawings of the present invention, “TRx” indicates a terminal that may function as an optical transmitter and an optical receiver, and that may receive both a wired service and a wireless service. Additionally, the terminal may be located in a separable base station.

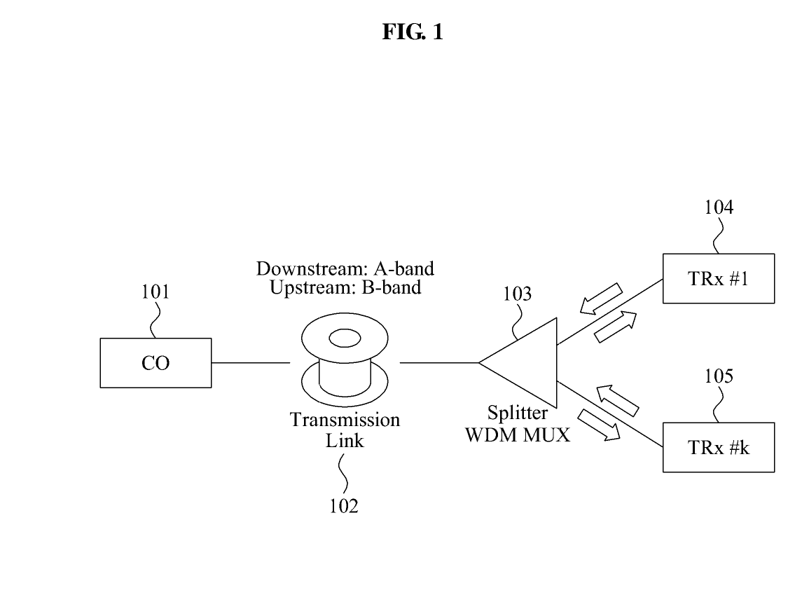

FIG. 1 is a diagram illustrating an optical link based on a wavelength division multiplexing (WDM) scheme, or an optical link based on a time division multiplexing (TDM) scheme, according to an embodiment of the present invention.

In FIG. 1, when the WDM scheme is independently used, or when the WDM scheme is used together with another multiplexing scheme, different wavelength bands may be selected for a downstream signal and an upstream signal, to improve a transmission quality. Specifically, referring to FIG. 1, OLT (Optical Line Terminal) in a central office (CO) 101 may transfer, to a splitter 103, a downstream signal corresponding to a wavelength band A through an optical link 102, and the downstream signal passing through the splitter 103 may be transferred to terminals 104 and 105. Additionally, the terminals 104 and 105 may transmit, to the CO 101, an upstream signal corresponding to a wavelength band B, through the optical link 102 and the splitter 103.

In this instance, the wavelength band A of the downstream signal, and the wavelength band B of the upstream signal may be have some relation. In the system with wavelength division multiplexer/demultiplexer (WDM MUX/DeMUX)-based optical distribution network (ODN), the wavelength band A and the wavelength band B may be spaced apart from each other by an integer multiple of a free spectral range (FSR) of a WDM MUX/DeMUX. In the system with splitter-based ODN, the relation between wavelength band A and the wavelength band B can be set by the service operators.

In the TRx_i, the downstream signal is received using the wavelength λai in the wavelength band A, and the upstream signal is transmitted using the wavelength λbi in the wavelength band B. The λai and the λbi also can have the relation, and the wavelength difference between λai and λbi can be a fixed or can be changed. If the wavelength difference between λai and λbi is changed due to some wavelength resource administration, the λbi is tuned to λbj.

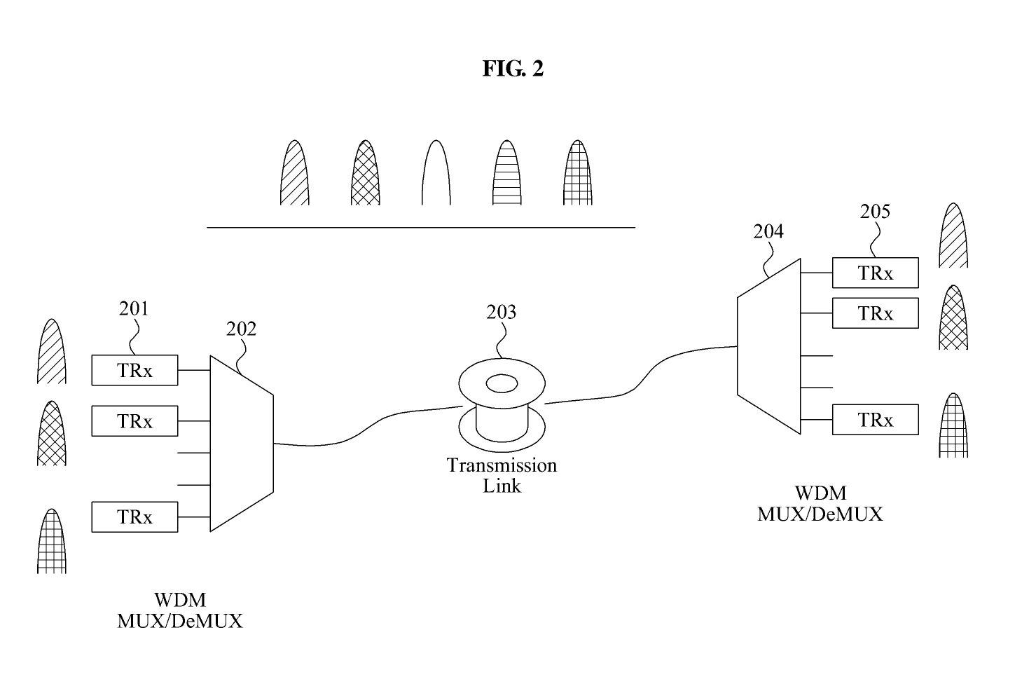

FIG. 2 is a diagram illustrating an optical link to which a WDM scheme is applied, according to an embodiment of the present invention.

Referring to FIG. 2, downstream signals transmitted by terminals 201 in a transmission side may be transferred to a WDM MUX/DeMUX 204 in a reception side through a WDM MUX/DeMUX 202 and an optical link 203.

Subsequently, each of terminals 205 in the reception side may acquire information on a channel related to the terminals 205, using a wavelength of the downstream signal received through the WDM MUX/DeMUX 204. In this instance, each of the terminals 205 may initialize an output wavelength to be a wavelength that is spaced apart by an FSR from the wavelength of the received downstream signal.

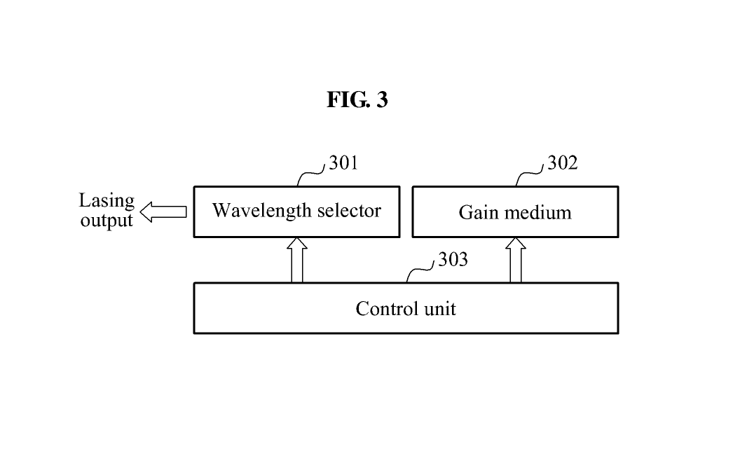

FIG. 3 is a diagram illustrating a detailed configuration of a wavelength variable optical source or a wavelength selectable optical source, according to an embodiment of the present invention.

The wavelength variable optical source may refer to an optical source that may enable an output wavelength of the optical source to be selectively varied using an electrical control interface. The wavelength selectable optical source may refer to an optical source that may enable selection of an output wavelength of the optical source based on an external control. In a case of a wavelength selectable optical source, a control unit 303 may be required only when a wavelength is initialized in an initial stage, without needing to be continuously connected.

When output light is output through a gain medium 302, a wavelength selector 301 may select a wavelength of the output light. In this instance, the wavelength selector 301 may include, for example, a waveguide Bragg grating (WBG), a thin film filter (TFF), or a filter formed of a liquid crystal. Here, the WBG is separated from a gain medium or is a portion of the gain medium. Additionally, to change the wavelength of the output light, mechanical properties (for example, an interval) by an external removable scheme may be used, or a refractive index of a waveguide or a refractive index of liquid crystal in a filter may be changed by applying an electrical signal.

Hereinafter, description will be given of a method of installing a broadband optical source for wavelength initialization in a CO, or a method of adjusting a wavelength selectable optical source or a wavelength variable optical source that is located in a subscriber using downstream optical signals having different wavelength bands.

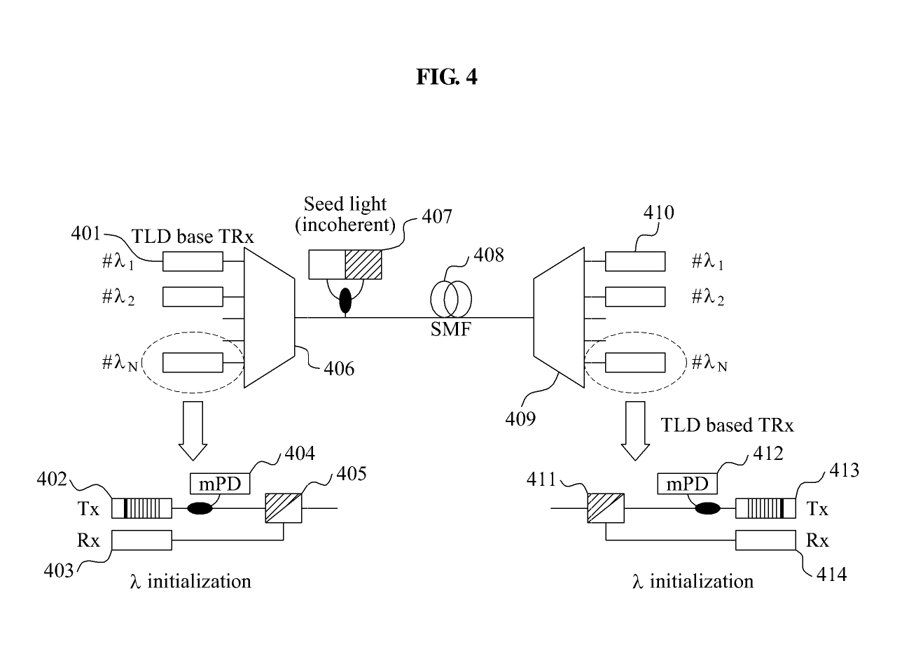

FIG. 4 is a diagram illustrating a configuration of an optical link for wavelength initialization according to an embodiment of the present invention.

As shown in FIG. 4, a low-output and low-cost broadband optical source may be installed for wavelength initialization. Optical transceivers 401 in a transmission side (namely, a CO) may transmit downstream signals to optical transceivers 410 in a reception side (namely, a subscriber), in different wavelengths, based on seed light derived through a seed light source 407. In this instance, the downstream signals may be transferred to the optical transceivers 410, through an optical link that includes WDM MUX/DeMUXs 406 and 409 and a single mode optical fiber 408.

In this instance, each of the optical transceivers 401 may monitor, through a monitor photodiode (mPD) 404, an amount of an incident optical signal to be reflected from a Bragg grating engraved in an optical waveguide of an optical transmitter 402. Subsequently, each of the optical transceivers 401 may match a peak wavelength of the Bragg grating to a wavelength of the seed light reaching the optical transceivers 401, by adjusting the peak wavelength of the Bragg grating so that a reflected optical power may have a maximum value. Accordingly, an output wavelength of the optical transmitter 402 may be matched to a transmission wavelength of the WDM MUX/DeMUXs 406 and 409.

Operations of the optical transceivers 401 may equally be applied to the optical transceivers 410, and accordingly further description thereof is omitted herein.

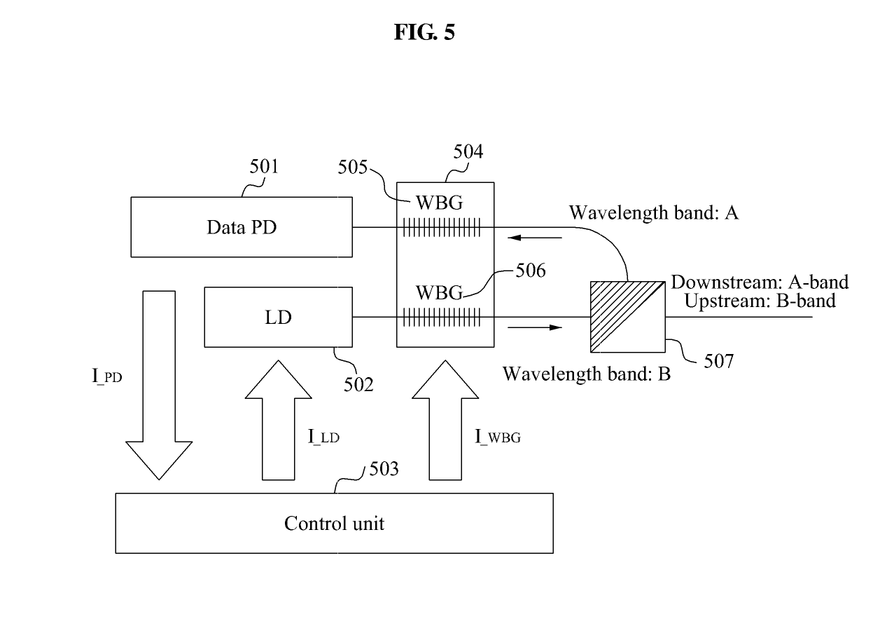

FIG. 5 is a diagram to explain a wavelength initialization method using a WBG as a wavelength selective filter according to an embodiment of the present invention.

Referring to FIG. 5, an optical receiver 501 and an optical transmitter 502 may be connected to WBGs 505 and 506, respectively, and both the WBGs 505 and 506 may be placed on a control unit 503. The control unit 503 may change a peak wavelength of a Bragg grating, by modifying a period of a WBG. For example, when a refractive index of a waveguide is changed based on a temperature, the control unit 503 may be a heater.

A wavelength band A of a downstream signal received by the optical receiver 501, and a wavelength band B of an upstream signal transmitted by the optical transmitter 502 may need to be spaced apart from each other by an integer multiple of an FSR of a WDM MUX/DeMUX. Additionally, a central Bragg wavelength of the WBG 505 connected to the optical receiver 501, and a central Bragg wavelength of the WBG 506 connected to the optical transmitter 502 may be spaced apart from each other by the FSR of the WDM MUX/DeMUX, and may be equally controlled by the control unit 503.

Accordingly, the control unit 503 may control the WBG 505 so that power of an optical signal incident on the optical receiver 501 may have a maximum value, and thus the WBG 506 connected to the optical transmitter 502 may be equally controlled. Accordingly, an output wavelength of the optical transmitter 502 may be initialized to be arranged in a transmission wavelength band of WDM MUX/DeMUX.

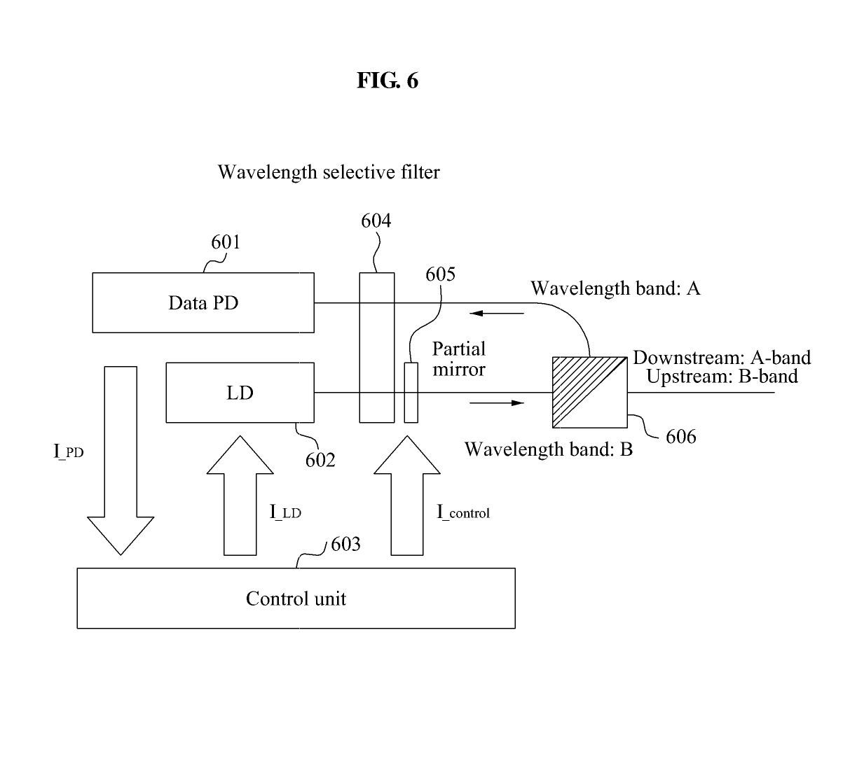

FIG. 6 is a diagram to explain a wavelength initialization method using a wavelength selective filter that is different from the wavelength selective filter of FIG. 5 according to an embodiment of the present invention.

In the wavelength initialization method of FIG. 6, a wavelength selective filter including a liquid crystal and the like, instead of the WBGs 505 and 506 of FIG. 5, may be used. Additionally, a partial mirror 605 may be located in front of a wavelength selective filter 604 connected to an optical transmitter 602. In FIG. 6, an FSR of the wavelength selective filter 604 may need to be identical to an FSR of a WDM MUX/DeMUX.

Accordingly, a control unit 603 may control the wavelength selective filter 604 so that power of an optical signal incident on an optical receiver 601 may have a maximum value. Thus, a wavelength of the optical transmitter 602 may be initialized to be matched to a central transmission wavelength band of WDM MUX/DeMUX in a link.

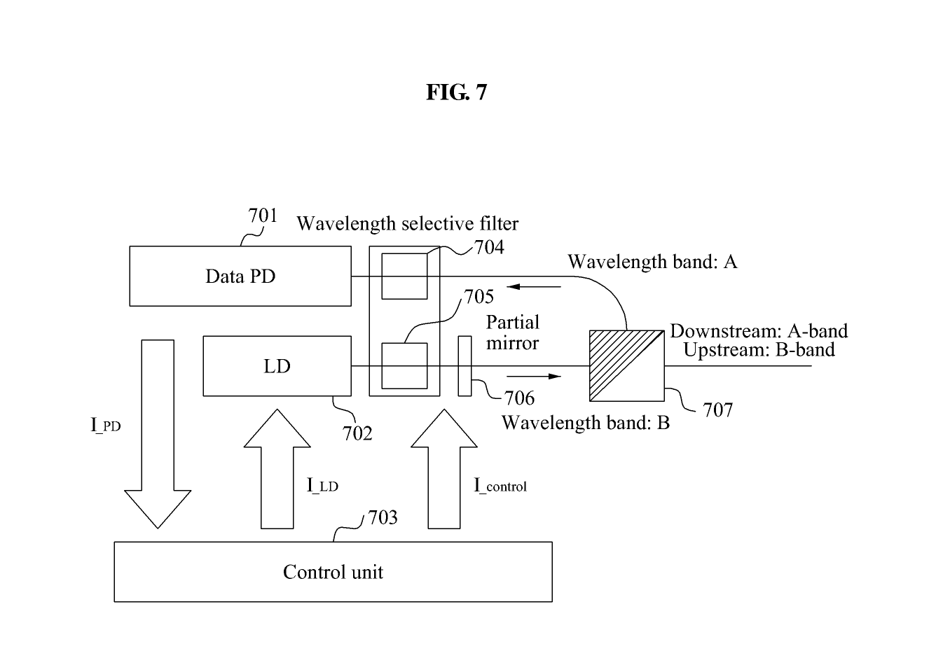

FIG. 7 is a diagram to explain a wavelength initialization method in which an optical transmitter and an optical receiver use different wavelength selective filters, according to an embodiment of the present invention.

As shown in FIG. 7, a wavelength selective filter 705 connected to an optical transmitter 702 may be different from a wavelength selective filter 704 connected to an optical receiver 701, unlike FIG. 6. In this instance, FSRs of the wavelength selective filters 704 and 705 may not need to be identical to an FSR of a WDM MUX/DeMUX.

However, a control unit 703 may control a transmission wavelength of wavelength selective filter 704 and a transmission wavelength of the wavelength selective filter 705 to be spaced apart from each other by an interval that corresponds to the FSR of the WDM MUX/DeMUX, so that a wavelength of the optical transmitter 702 may be initialized.

An example in which a WDM MUX/DeMUX is used in an optical link has been described above with reference to FIGS. 2 through 7. However, when only an optical power splitter is located in the optical link, wavelength identification (ID) for each wavelength may be provided to each subscriber using a specifically assigned wavelength. And the TRx in each subscriber is set a initial wavelength condition to receive the specifically assigned wavelength, and adjusts each of assigned wavelength for communication of TRx by searching wavelength channel information. In this instance, a used protocol may be defined to perform dynamic wavelength allocation and the like, similarly to a protocol to allocate time slots for each subscriber in a TDM scheme. If there are multiple OLTs (COs), one of multiple OLTs can use domain master to manage the wavelength assignments.

So, unrelated to distributor of ODN such as splitter and WDM MUX/DeMUX, optical transceiver controls a wavelength selector to be maximum power of optical signal inputted to optical receiver, by a control unit, and initializes a output wavelength of optical transmitter as channel for available communication, by the control unit.

The methods according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical transceiver, comprising:
an optical receiver to receive a downstream signal using a first wavelength selective filter comprising a first waveguide Bragg grating (WBG);
a control unit to control the first WBG to initialize a wavelength, so that the optical receiver receives a maximum optical power; and
an optical transmitter to transmit an upstream signal using a second wavelength selective filter comprising a second WBG,
wherein the second WBG is controlled by the control unit, together with the first WBG.

2. The optical transceiver of claim 1, wherein the first WBG and the second WBG is separated from a gain medium or is unified with the gain medium.

3. The optical transceiver of claim 1, wherein a central Bragg wavelength of the first WBG and a central Bragg wavelength of the second WBG are set to be spaced apart from each other by a free spectral range (FSR) of a wavelength division multiplexer/demultiplexer (WDM MUX/DeMUX).

4. The optical transceiver of claim 1, wherein the upstream signal and the downstream signal are located in wavelength bands that are spaced apart from each other by an integer multiple of an FSR of a WDM MUX/DeMUX.

5. An optical transceiver, comprising:
an optical receiver to receive a downstream signal using a first wavelength selective filter;
a control unit to control the first wavelength selective filter to initialize a wavelength, so that the optical receiver receives a maximum optical power; and
an optical transmitter to transmit an upstream signal using a second wavelength selective filter connected to a partial mirror.
wherein the second wavelength selective filter is controlled by the control unit, together with the first wavelength selective filter.

6. The optical transceiver of claim 5, wherein a free spectral range (FSR) of the wavelength selective filter is identical to an FSR of a wavelength division multiplexer/demultiplexer (WDM MUX/DeMUX).

7. The optical transceiver of claim 5, wherein the optical receiver receives an downstream signal using a first wavelength selective filter, and
wherein the optical transmitter transmits a upstream signal using a second wavelength selective filter that is different from the first wavelength selective filter.

8. The optical transceiver of claim 7, wherein a transmission wavelength of the first wavelength selective filter, and a transmission wavelength of the second wavelength selective filter are spaced apart from each other by an interval that corresponds to an FSR of a WDM MUX/DeMUX.

9. The optical transceiver of claim 4 being connected to an optical link comprising a WDM MUX/DeMUX.

10. The optical transceiver of claim 4 being one of elements included in a network in which a wired network and a wireless network are combined.

11. An optical transceiver is connected to the splitter of optical link, comprising:
an optical receiver to receive a downstream signal using a iₜₕ wavelength of first wavelength band; and
an optical transmitter to transmit an upstream signal using a iₜₕ wavelength of second wavelength band,
wherein the difference between the iₜₕ wavelength of the first wavelength band and the iₜₕ wavelength of the second wavelength band is fixed or changed.

12. An optical transceiver, comprising:
an optical receiver to receive a downstream signal in a first wavelength of first wavelength band;
a control unit to control a first wavelength selective filter so that the optical receiver receives a maximum optical power; and
an optical transmitter to transmit an upstream signal using a second wavelength selective filter in a second wavelength of second wavelength band,
wherein the second wavelength selective filter is controlled by the control unit, together with the first wavelength selective filter.

13. The optical transceiver of claim 12, when at least one of the first wavelength selective filter and the second wavelength selective filter are multiple thin filter, wherein the control unit control a refractive of multiple thin filter by applying the electric, and when at least one of the first wavelength selective filter and the second wavelength selective filter are waveguide Bragg grating, wherein the control unit control a grating period of waveguide Bragg grating by applying the heat.

14. A wavelength initialization method performed by an optical transceiver comprising an optical transmitter, an optical receiver, and a control unit, the wavelength initialization method comprising:
receiving, by the optical receiver, a downstream signal using a wavelength selective filter comprising a first waveguide Bragg grating (WBG);
controlling, by the control unit, the first WBG to initialize a wavelength, so that the optical receiver receives a maximum optical power; and
transmitting, by the optical transmitter, an upstream signal using a wavelength selective filter comprising a second WBG,
wherein the second WBG is controlled by the control unit, together with the first WBG.

15. The wavelength initialization method of claim 14, wherein the first WBG and the second WBG is separated from a gain medium or is unified with the gain medium.

16. The wavelength initialization method of claim 14, wherein a central Bragg wavelength of the first WBG and a central Bragg wavelength of the second WBG are set to be spaced apart from each other by a free spectral range (FSR) of a wavelength division multiplexer/demultiplexer (WDM MUX/DeMUX).

17. The wavelength initialization method of claim 14, wherein the upstream signal and the downstream signal are located in wavelength bands that are spaced apart from each other by an integer multiple of an FSR of a WDM MUX/DeMUX.

18. A wavelength initialization method performed by an optical transceiver comprising an optical transmitter, an optical receiver, and a control unit, the wavelength initialization method comprising:
receiving, by the optical receiver, a downstream signal using the first wavelength selective filter;
controlling, by the control unit, the first wavelength selective filter to initialize a wavelength, so that the optical receiver receives a maximum optical power; and
transmitting, by the optical transmitter, an upstream signal using a second wavelength selective filter connected to a partial mirror,
wherein the second wavelength selective filter is controlled by the control unit, together with the first wavelength selective filter.

19. The wavelength initialization method of claim 18, wherein a free spectral range (FSR) of the wavelength selective filter is identical to an FSR of a wavelength division multiplexer/demultiplexer (WDM MUX/DeMUX).

20. The wavelength initialization method of claim 18,
wherein the receiving comprises receiving, by the optical receiver, a downstream signal using the first wavelength selective filter
wherein the controlling comprises controlling, by the control unit, the first wavelength selective filter to initialize the wavelength, so that the optical receiver receives the maximum optical power, and
wherein the transmitting comprises transmitting, by the optical transmitter, an upstream signal using a second wavelength selective filter different from the first wavelength selective filter.

21. The wavelength initialization method of claim 18, wherein a transmission wavelength of the first wavelength selective filter, and a transmission wavelength of second wavelength selective filter are spaced apart from each other by an interval that corresponds to an FSR of a WDM MUX/DeMUX.

22. The wavelength initialization method of claim 18, wherein the optical transceiver is connected to an optical link comprising a WDM MUX/DeMUX.

23. The wavelength initialization method of claim 18, wherein the optical transceiver is one of elements included in a network in which a wired network and a wireless network are combined.

24. A wavelength initialization method performed by an optical transceiver comprising an optical transmitter, and an optical receiver, the wavelength initialization method comprising:
receiving, by the optical receiver, a downstream signal using a iₜₕ wavelength of first wavelength band; and
transmitting by the optical transmitter, an upstream signal using the iₜₕ wavelength of second wavelength band,
wherein the difference between the iₜₕ wavelength of the first wavelength band and the iₜₕ wavelength of the second wavelength band is fixed or changed.

25. A wavelength initialization method performed by an optical transceiver comprising an optical transmitter, an optical receiver, and a control unit, the wavelength initialization method comprising:
receiving, by the optical receiver, a downstream signal in a first wavelength of first wavelength band;
controlling, by the control unit, a first wavelength selective filter so that the optical receiver receives a maximum optical power; and
transmitting, by the optical transmitter, an upstream signal using a second wavelength selective filter in a second wavelength of second wavelength band,
wherein the second wavelength selective filter is controlled by the control unit, together with the first wavelength selective filter.

26. The wavelength initialization method of claim 25, when at least one of the first wavelength selective filter and the second wavelength selective filter are multiple thin filter, wherein the control unit control a refractive of multiple thin filter by applying the electric, and
when at least one of the first wavelength selective filter and the second wavelength selective filter are waveguide Bragg grating, wherein the control unit control a grating period of waveguide Bragg grating by applying the heat.
